(19) United States
(12) Patent Application Publication
(10) Pub. No.: US 2008/0052467 A1
(43) Pub. Date: Feb. 28, 2008

(54) System for restricted cache access during information transfers and method thereof

(75) Inventor: Stephen P. Thompson, Longmont, CO (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Advanced Micro Devices, Inc., Sunnyvale, CA (US)

(21) Appl. No.: 11/510,370

(22) Filed: Aug. 25, 2006

(51) Int. Cl. G06F 12/00; G06F 12/14

(52) U.S. Cl. 711/128; 711/163

(57) ABSTRACT

Instructions involving a relatively significant information transfer or a particular type of information transfer via a cache, or specified address ranges within cache causing a cache miss result in the application of a restricted access policy to control access to one or more partitions of the cache so as to reduce or prevent the overwriting of information that is expected to be subsequently used by the cache or by a processor. A processor or other system component may assert a signal which is utilized to select between one or more access policies based on instructions or their type so that an access may be applied to control access to one or more ways of the cache during the information transfer operation associated with the instruction. Similarly, a cache way select module may select between one or more access policies based on an address range so that an access policy may be applied to control access to one or more ways of the cache during access to a specific range of memory. The access policy typically represents an access restriction to particular cache partitions, such as a restriction to one or more particular cache ways or one or more particular cache lines.

### CROSS-REFERENCE TO RELATED APPLICATIONS

The present application is related to U.S. patent application Ser. No. 11/052,650 (Client Reference No. P0005; Attorney Docket No.: 1458-P0005) entitled “SYSTEM HAVING CACHE MEMORY AND METHOD OF ACCESSING,” and filed on Feb. 7, 2005, the entirety of which is incorporated by reference herein.

### FIELD OF THE DISCLOSURE

The present disclosure is related generally to caching in processing systems and more specifically to restricting access to cache during information transfers.

### BACKGROUND

Cache memories often are utilized in processing systems to store information such as application data or instructions to be utilized by a processor or to be subsequently stored in more permanent memory, such as system memory or a hard disk. To illustrate, in personal computing systems, graphics drivers often utilize caches to move large blocks of video data between system memory and one or more video frame buffers. To implement such a transfer, the graphics driver may employ a tight loop or an x86 REP command to repeatedly implement a move function to sequentially transfer the block of information from memory to the frame buffer, or vice versa, via a cache. However, such a technique typically has the effect that information in the cache is overwritten by the video data being transferred. It will be appreciated that overwriting information already in the cache may reduce cache efficiency as the overwritten information may need to be reinserted into the cache subsequent to the transfer of the video data out of the cache, and this reinsertion of information often results in a significant delay or a stalling of the processor. Similarly, information stored at a specific location in memory may be more important than information stored at a different location. Accordingly, a technique to prevent or reduce the overwriting of frequently used information in a cache during information transfers would be advantageous.

### BRIEF DESCRIPTION OF THE DRAWINGS

The purpose and advantages of the present disclosure will be apparent to those of ordinary skill in the art from the following detailed description in conjunction with the appended drawings in which like reference characters are used to indicate like elements, and in which:

FIG. 1 is a block diagram illustrating an exemplary processing system in accordance with at least one embodiment of the present disclosure.

FIGS. 2, 5, 7, and 9 are block diagrams illustrating exemplary cache control modules in accordance with at least one embodiment of the present disclosure.

FIGS. 3, 4, 6, 8, and 10-12 are flow diagrams illustrating exemplary cache access control methods in accordance with at least one embodiment of the present disclosure.

### DETAILED DESCRIPTION OF THE DRAWINGS

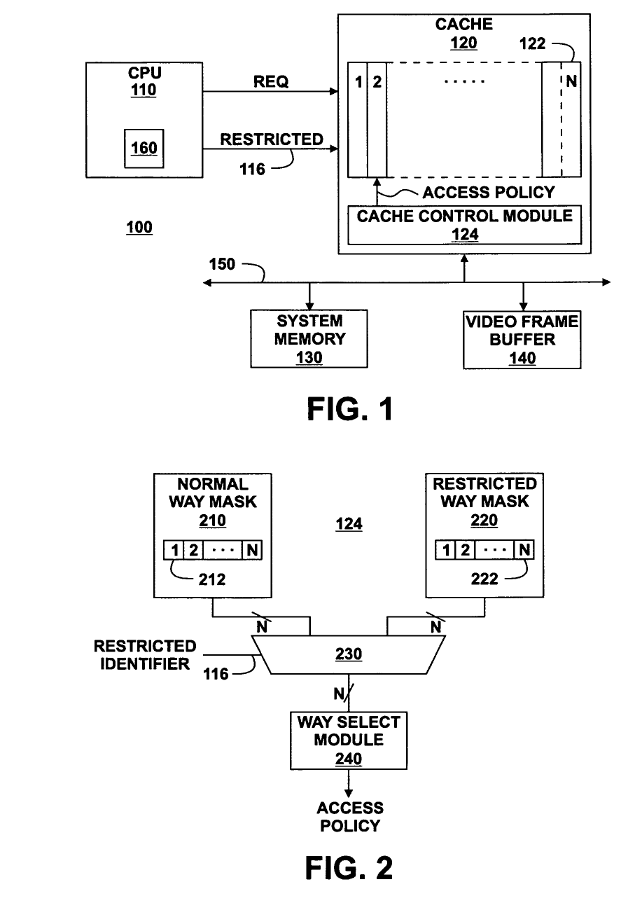

FIGS. 1-8 illustrate exemplary systems and techniques whereby cache access may be controlled during a transfer of information via the cache. In at least one embodiment, instructions related to non-information transfer operations or to operations involving relatively small information transfers via the cache, result in the application of a first access control policy to control access to one or more partitions of a cache during the use of the cache by a processor. In contrast, for instructions involving a relatively significant information transfer or a particular type of information transfer, result in the application of a second access policy to control access to one or more partitions of the cache so as to reduce or prevent the overwriting of information that is expected to be subsequently used by the cache or by a processor. As described in greater detail herein, the type or magnitude of the information transfer associated with a particular operation may be determined based upon an inspection or comparison of a prefix field and/or an opcode field of the instruction. In response to this comparison or inspection, a processor or other system component may assert a signal which is utilized to select between one or more access policies and the selected access policy then may be applied to control access to one or more ways of the cache during the information transfer operation associated with the instruction. The access policy typically represents an access restriction to particular cache partitions, such as a restriction to one or more particular cache ways or one or more particular cache lines. The access policy related to an access restriction to particular cache ways may be represented by, for example a cache way mask. The restriction to particular cache partitions may be selected using, for example, least recently used (LRU) information maintained for the cache.

In an alternate embodiment, the address of information resulting in a cache miss is compared to an address range to identify a cache way mask to be used.

Referring now to FIG. 1, an exemplary system 100 that utilizes an exemplary cache control mechanism is illustrated in accordance with at least one embodiment of the present disclosure. The system 100 includes a processor 110, such as a central processing unit (CPU), a cache 120, which as illustrated, includes a cache memory 122 having a plurality of ways (denoted as ways 1-N) for each of a plurality of cache rows, and a cache control module 124 (e.g., a software, hardware or firmware module). As used herein, the term cache row refers to a set of cache lines associated with a common index, each cache row of each way having a cache tag. The cache memory 120 may comprise, for example, a 16-way, 128-row cache with each cache line capable of storing 32 bytes of information. The system 100 further may comprise one or more modules that utilize the cache 120, such as system memory 130 and display frame buffer 140 coupled to the cache 120 and/or the processor 110 via, for example, a system bus 150.

In at least one embodiment, the cache 120 is utilized to store information for use by the processor 110 or utilized to facilitate the transfer of information between, for example, the system memory 130 and the display frame buffer 140. As will be appreciated, such transfers typically are initiated by the processor 110 prior to or during the execution of one or more instructions by the processor 110. As noted above, the storage for information for use by the processor 110 or the transfer of information may result in the overwriting of information already present in the cache memory 122. Being overwritten, this information consequently is unavailable for use by the processor 110 during subsequent operations, and therefore the overwriting of this information may hinder the efficiency of the processor 110 as well as the cache 120. Accordingly, in at least one embodiment, the cache control module 124 may implement a cache access control policy that restricts access to one or more portions (e.g., one or more ways or one or more cache blocks) of the cache memory 122 during certain types of information transfers and information storages in the cache memory 122. This access control policy may identify a subset of the plurality of ways or cache blocks that contain information expected to be used by the processor 110 subsequent to the information transfer or information storage operation, as well as those ways/cache blocks of the cache memory 122 that may contain information that is not expected to hold or store information to be utilized by the processor 110 subsequent to the information transfer. The access control policy therefore may identify those ways/cache blocks which may be utilized during the information transfer operation without substantially impeding the efficiency of the information processor 110 in its use of the cache 120. As discussed in detail herein, the access control policy may be implemented by one or more sets of cache masks that indicate those ways of the cache memory 122 which may be used to store information during an information transfer operation, as well as those ways which are prohibited from being used during an information transfer operation. It will be appreciated that information transfers from system memory 130 resulting in information being stored at cache 120 can include instruction information transfers from instruction space of memory 130 or application information transfers from data space (i.e. not instruction space) of memory 130.

The particular access policy utilized during an information transfer operation, in one embodiment, is selected based on a restricted identifier signal 116 provided or asserted by the processor 110 in response to, or in preparation of, an execution of a particular information transfer operation. Based on the signal 116 asserted or provided by the processor 110, the cache control module 124 selects an access policy to apply to the cache memory 122 so as to limit or prevent access to one or more ways of the cache memory 122.

The processor 110 may utilize an instruction analysis module 160 (e.g., a software, hardware or firmware module) to analyze instructions to be executed or currently executed by the processor 110 so as to determine whether to assert the signal 116. In one embodiment, the module 160 determines whether to assert the restricted identifier signal 116 based on a determination that an instruction to be executed is identified as a particular type of instruction associated with the transfer of transient information or large blocks of information, such as video data. Based on this identification, the module 160 may operate the processor 110 so as to assert the restriction signal 116 or directly assert the signal 116.

In one embodiment, particular instructions associated with large information transfers or information transfers of relatively transient information are identified based upon at least one of a prefix field or an opcode field of the instruction currently executed or to be executed. To illustrate, the REP instruction (prefix 0x F3 in the x86 architecture) is commonly used in the x86 processing architecture to repeat certain instructions such as the move string (MOVS) instruction (opcode 0xA4 or 0xA5 in the x86 architecture, depending upon operand size). Accordingly, the module 160 may analyze an instruction to be executed by the processor 110 to determine whether the prefix field of the instruction to be executed substantially matches the prefix field associated with the REP instruction. Further, the module 160 may also scrutinize the opcode field to be executed to determine whether it substantially matches the opcode value associated with the move string instruction. Should one or both of the fields of the instruction to be executed match the fields of a REP MOVS instruction, the module 160 may cause the restriction signal 116 to be asserted. However, it will be appreciated that in some instances, the REP MOVS instruction may be utilized in operations that do not utilize relatively large blocks of information or do not transfer transient information. Accordingly, in at least one embodiment, the REPNE instruction (prefix 0xF2 in the x86 architecture) may be utilized to identify information transfer operations that are to have restricted cache access. To illustrate, a particular instruction typically not utilized, such as the REPNE MOVS command may be utilized to particularly identify an information transfer operation that involves large blocks of information or relatively transient information via the cache 120. In this embodiment, the module 160 may scrutinize operations to be executed by the processor 110 to identify those that utilize the particular operation (e.g., the REPNE MOVS operation). Based on the identification of this unique operation, the module 160 may cause the restricted identifier signal 116 to be asserted.

Referring now to FIG. 2, an exemplary implementation of the cache control module 124 is illustrated in accordance with at least one embodiment of the present disclosure. As depicted, the cache control module 124 may comprise a normal way mask module having one or more cache masks 212, a restricted way mask module 220 (e.g., a software, hardware or firmware module) having one or more cache masks 222, a multiplexer 230 having as inputs the output from the normal way mask module 210 and the output of the restricted way mask module 220 and having as a select input the restricted signal 116, which may be provided by the processor 110. The multiplexer 230 selects as its output one of the cache masks 212 from the normal way mask, or one of the cache masks 222 from the restricted way mask module 220 based upon the value of the signal 116. In the event that the instruction to be executed by the processor 110 is not identified as an instruction involving the transfer of a large block of information or the transfer of transient information, the signal 116 may be de-asserted, thereby resulting in the provision of a cache mask 212 from the normal way mask module 210(e.g., a software, hardware or firmware module) at the output of the multiplexer 230. In contrast, an instruction to be executed by the processor 110 that is identified as involving the transfer of a large block of information or the transfer of transient information may result in the processor 110 asserting the signal 116, which in turn results in the output of one or more cache masks 222 at the output of the multiplexer 230.

The way select module 240 receives the one or more cache masks output by the multiplexer 230 and applies them as the access policy of the cache memory 122 so as to restrict access to one or more ways of the cache memory 122 during the execution of the instruction at the processor 110. As illustrated, the cache module 212 and 222 may comprise a plurality of fields where each field corresponds to one of the plurality of ways of the cache memory 122, and wherein access to a particular way of the cache memory 222 is controlled based on the value (i.e., 0 or 1) stored at the field of the cache mask associated with a particular way. Alternatively, the cache masks 212 or 222, may comprise a plurality of fields, each field associated with a particular cache line, wherein the value stored in each field of the prior fields controls access to the corresponding cache line.

In at least one embodiment, the cache mask 212 implemented during operations that do not involve the transfer of large blocks of information or the transfer of transient information typically are less restrictive than the cache mask 222 implemented during operations involving the transfer of transient information or large blocks of information, so as to prevent or limit the amount of overwriting of valid information which is expected to be used by the processor 110 subsequent to the information transfer operation. The particular access control policy to be implemented using the cache mask 212 or cache mask 222 may be predetermined or may be constructed or modified on the fly by, for example, an operating system 250 executed by the processor 110 or other processing device. To illustrate, the operating system 250 or other component of the cache 120 may monitor the cache memory 122 to determine or identify those portions of the cache which have been either most recently used, least recently used, or having some other appropriate performance parameter. Using this information, the operating system may set one or both of the cache masks 212 or 222 so as to protect those ways identified as being frequently used or most recently used, while allowing access to those ways identified as being the least frequently used or used last. Other considerations, such as the amount of valid information stored in a particular way, further may be utilized to determine whether or not access to a particular way should be granted in a particular access control policy. Although an exemplary implementation of a control access policy utilizing cache masks is illustrated, those skilled in the art may, using the guidelines provided herein, implement cache access policies utilizing other techniques without departing from the spirit or the scope of the present disclosure.

The way select module 240, in one embodiment, receives the cache mask output by the multiplexer 230 and implements the access control policy represented by the output cache mask. In one embodiment, the cache way mask contains a bit for each way of the cache. If a bit is asserted in the mask, then the corresponding way will not be replaced by the information being accessed. The cache controller will instead select a way to be overwritten with the new information among the ways having deasserted mask bits using conventional cache replacement policies (e.g., least-recently-used way or an unused way). In one embodiment, it will be appreciated that a mask state of a specific cache way of the plurality (N) of cache ways is stored a specific offset location within each corresponding way mask. For example, the left-most bit of each of way mask 210 and way masks 220 corresponds to a first way of the cache 120. While each cache way is represented by a single bit in each of the cache masks, it will be appreciated that more that one bit can :used to represent a specific cache way.

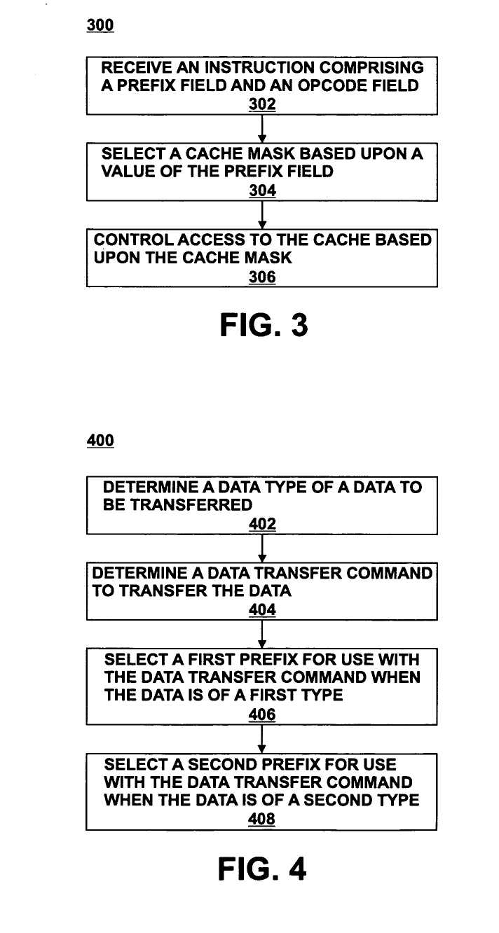

Referring now to FIG. 3, an exemplary method 300 for controlling access to a cache is illustrated in accordance with at least one embodiment of the present disclosure. The method 300 initiates at step 302 wherein an instruction comprising a prefix field and an opcode field is received. At step 304, a cache mask is selected based on a value of the prefix field. Selecting the cache mask may include selecting a first cache mask when the prefix field matches a first predefined value and selecting a second cache mask when the prefix field matches a second predefined value. At step 306, access to a cache is controlled based on the selected cache mask. The opcode field may represent an information transfer instruction, such as the MOVS instruction, and the prefix field may represent a repeat-type instruction, such as REP, REPE, or REPNE. Access to the cache may be restricted by tag, way or a combination thereof.

Referring now to FIG. 4, another exemplary method 400 for controlling access to a cache is illustrated in accordance with at least one embodiment of the present disclosure. The method 400 initiates at step 402 wherein an information type of information to be transferred is determined. At step 404, an information transfer operation to transfer the information is determined. At step 406, a first prefix for use with the information transfer operation is selected when the information is of a first type. At step 408, a second prefix for use with the information transfer operation is selected when the information is of a second type. In one embodiment, the information of a first type is video data and information of the second type is different than the information of the first type. In another embodiment, the information of a first type is information to be transferred to a video frame buffer or the information of a first type is transient information is not subject to reuse. The first prefix may be selected to facilitate selection of a first cache mask and the second prefix is selected to facilitate selection of a second cache mask.

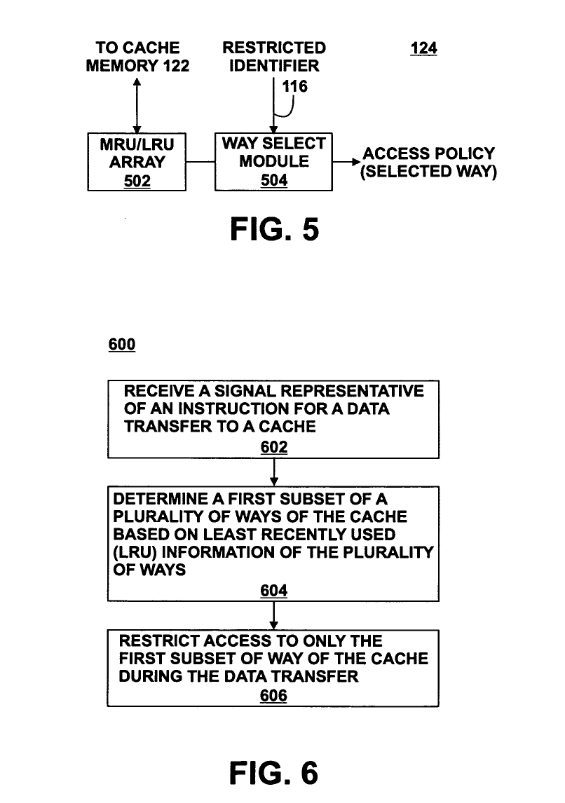

Referring now to FIGS. 5 and 6, another exemplary implementation of the cache control module 124 is illustrated in accordance with at least one embodiment of the present disclosure. In the illustrated example of FIG. 5, the cache control module 124 comprises a most recently used (MRU)/least recently used (LRU) array 502 connected to a way select module 504. The MRU/LRU array 502 is used to maintain LRU and/or MRU information for the cache ways, cache rows and/or cache lines (or any other type of cache partition). The way select module 504, in response to receipt of the restricted identifier signal 116, in turn, may utilize the MRU/LRU array 502 to identify one or more of the ways of the cache memory 122 (FIG. 1) that have the least recently used information (and therefore the least likely to be accessed by the processor 110). The way select module 504 then may implement an access policy for the cache memory 122 whereby the information transfer operation that triggered the assertion of the signal 116 is restricted to only those one or more ways of the cache memory as having the least recently used information.

The method 600 of FIG. 6 illustrates an exemplary operation using the control module 124 as illustrated in FIG. 5. The method 600 initiates at step 602 wherein a signal representative of an instruction for an information transfer to a cache (e.g., signal 116) is received. At step 604, a first subset of the plurality of ways of the cache based on least recently used (LRU) information of the plurality of ways is determined. At step 606, access is restricted to only the first subset of ways of the cache during the information transfer.

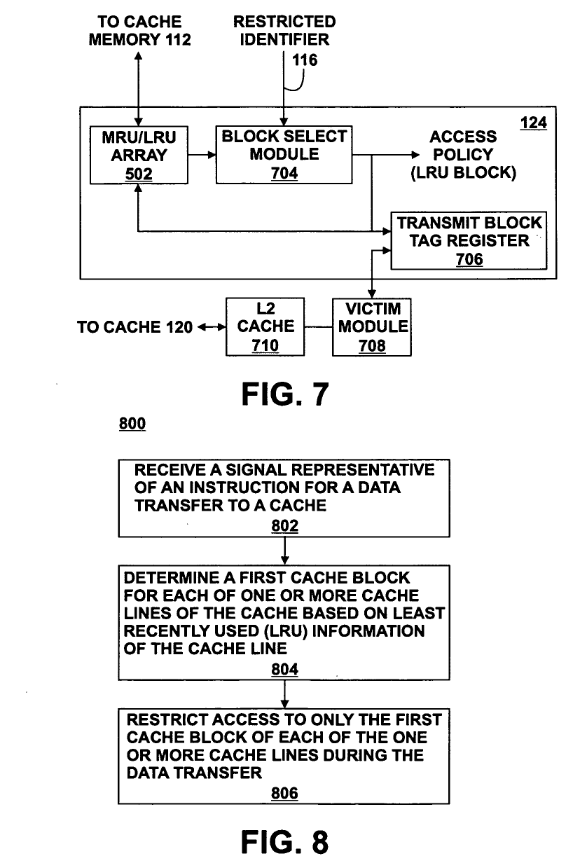

Referring now to FIGS. 7 and 8, another exemplary implementation of the cache control module 124 is illustrated in accordance with at least one embodiment of the present disclosure. In the illustrated example of FIG. 7, the cache control module 124 comprises the most recently used (MRU)/least recently used (LRU) array 502, a block select module 704 and a transient block tag register 706. As discussed above with reference to FIG. 5, the MRU/LRU array 502 is utilized to maintain LRU and/or MRU information about the cache memory 122. The block select module 704, using this information, may identify the least recently used cache line or lines for those cache rows to be used during an information transfer operation. The line select module 704 then may implement an access policy for the cache memory 122 that restricts access to only the identified LRU cache lines of the cache memory 122 during the information transfer operation.

In conventional systems, the transfer of transient information to particular partitions of the various caches results in an update in the MRU/LRU information associated with the cache partitions so as to reflect the writing of the transient information to the particular partitions. As the cache partitions holding this transient information are indicated as MRU information, the cache control logic typically will prevent the overwriting of these cache partitions until they become relatively aged compared to the other cache partitions. However, these cache partitions preferably would be accessible after the information transfer operation is complete as the transferred information was only transient in the cache. Accordingly, in one embodiment, the line select module 704 prevents the MRU/LRU array 502 from being updated during an information transfer operation involving transient information so that the LRU/MRU status of the cache lines used for the information transfer is not updated as a result of their use, or the line select module 704 may modify the MRU/LRU array 502 so that the entries of the array 706 corresponding to the cache lines used in the information transfer are changed to indicate that the cache lines were the least recently used cache lines. As a result, the cache lines used for storing transient information may be available for other operations following the information transfer operation.

It will be appreciated that conventional systems may utilize multiple cache levels whereby information is distributed among multiple caches during an information transfer operation. To illustrate, a processing system may utilize a level one (L1) cache, a level two (L2) cache to facilitate the temporary storage of information for use by a processor. However, after transient information is stored in a higher-level cache during an information transfer operation, the corresponding MRU/LRU information in conventional systems typically indicate that the transient information was most recently used and therefore might cause the overflow of information to a lower-level victim cache. To counter this situation, the line select module 704 further may maintain the transient line tag register 706 to reflect whether the corresponding cache lines of cache memory 122 contain transient information. To illustrate, the register 706 may comprise a one-bit field for each cache line of the cache memory 122. When a particular cache line is used to store transient information, the line select module 704 may write a “1”, for example, to the entry of the register 706 corresponding to the particular cache line to indicate that the particular cache line holds transient information.

The transient line tag register 706 then may be utilized in determining whether to spill information over to a victim cache. A victim module 708 associated with a lower-level cache, such as, for example, L2 cache 710, may analyze the register 706 before allowing information to be transferred to the L2 cache 710. In the event that a field of the register 706 associated with a particular cache line has a “1” to indicate that the cache line holds transient information, the victim module 708 directs the cache 120 to store the information in the cache line rather than spilling it over to the L2 cache 710. The victim module 708 then may clear the field of the register 706 by writing a “0” to indicate that the corresponding cache line no longer contains the transient information from the information transfer operation. Thus, when the victim module 708 detects a “0” in the field of the register 706 that corresponds to a particular cache line (thereby indicating that the information in the particular cache line isn't transient information), the victim module 708 may allow information to be spilled over to the L2 cache 710.

The method 800 of FIG. 8 illustrates an exemplary operation using the control module 124 as illustrated in FIG. 7. The method 800 initiates at step 802 wherein a signal representative of an instruction for an information transfer to a cache (e.g., signal 116) is received. At step 804, a first cache line for each of one or more cache rows of the cache is determined based on LRU information of the cache line. At step 806, access is restricted to only the first cache line of each of the one or more cache rows during the information transfer.

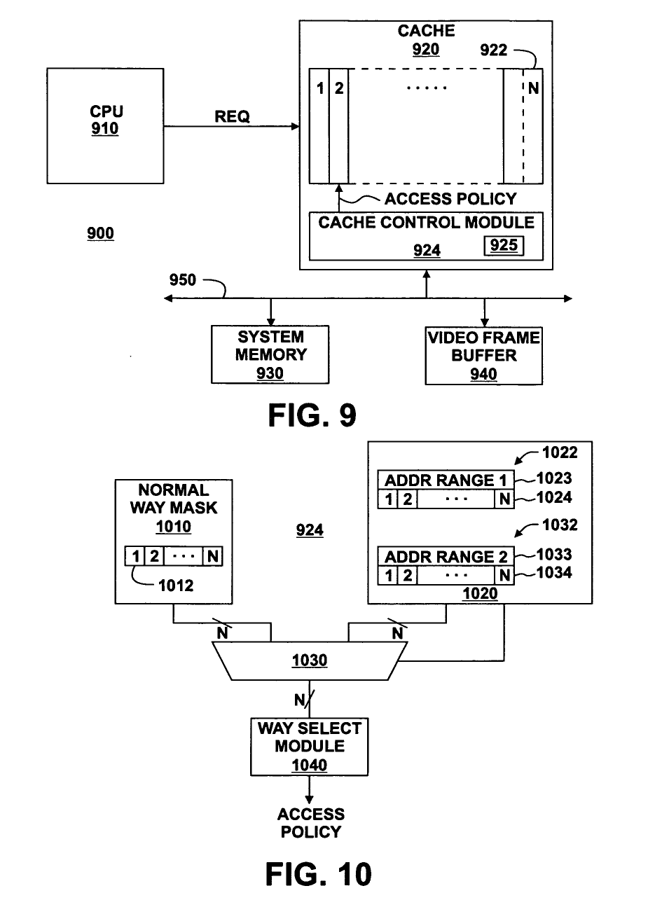

It will be appreciated that in an alternate cache way cache allocation can select amongst access policies using different or additional criteria than that previously described. For example, FIG. 9 illustrates an alternate embodiment of a system 900 that utilizes an exemplary cache control mechanism. System 900 is illustrated to include a CPU 910, Cache 920, system bus 950, system memory 930, and a video frame buffer 940.

CPU 910 is analogous to CPU 110 of FIG. 1. Though not specifically illustrated, it will be appreciated that the CPU 910 may include a module 160 as previously described to generate a restricted signal for use by the cache 920 based on an instruction or instruction type. Alternatively, the specific embodiment of FIG. 9 need not include a module similar to module 160 of FIG. 1 or its related functionality.

Bus 950, system memory 930, and video frame buffer 940 operate in similar manners as bus 150, system memory 130, and video frame buffer 140 as previously described. Cache module 920 is utilized to store information for use by the processor 910 or utilized to facilitate the transfer of information between, for example, the system memory 930 and the display frame buffer 940. As will be appreciated, such transfers typically are initiated by the processor 910, prior to or during the execution of one or more instructions by the processor 910. As noted above, the storage of information for use by the processor 910 or the transfer of information may result in the overwriting of information already present in the cache memory 922. Being overwritten, this information consequently is unavailable for use by the processor 910 during subsequent operations, and therefore the overwriting of this information may hinder the efficiency of the processor 910 as well as the cache 920. Accordingly, in at least one embodiment, the cache control module 924 may implement a cache access control policy that restricts access to one or more portions (e.g., one or more ways or one or more cache blocks) of the cache memory 922 during information transfers affecting one or more specific address ranges as identified in a storage location such as registers 925. This access control policy may identify a subset of a plurality of ways that contain information expected to be used by the processor 910 subsequent to the information transfer from a specific location in memory, as well as those ways/cache blocks of the cache memory 922 that may contain information that is not expected to hold or store information to be utilized by the processor 910 subsequent to the information transfer. The access control policy therefore may identify those ways/cache blocks that may be utilized during the information transfer operation without substantially impeding the efficiency of the information processor 910 in its use of the cache 920. As discussed in detail herein, the access control policy may be implemented by one or more sets of cache masks that indicate those ways of the cache memory 922 which may be used to store information during an information transfer operation, as well as those ways which are prohibited from being used during an information transfer operation.

FIG. 10 illustrates a normal way mask module 1010 and a restricted way mask select module 1020, which in the illustrated embodiment includes registers 1022 and 1032. Register 1022 includes a field 1023 that stores a first address range (ADDR RANGE1) and a restricted way mask 1024 corresponding to field 1023. Register 1032 includes a field 1033 that stores a first address range (ADDR RANGE2) and a restricted way mask 1034 corresponding to field 1033.

During operation, in response to a cache miss, one of the way masks 1010, 1024, and 1034 is used by the cache control module 1024 to modify the way select policy, thereby resulting in the cache policy being based upon an address of the information being accessed. Therefore, a restricted way mask of module 1020 is selected when an address causing the cache miss is within an address range of a corresponding address range field of module 1020. In addition, module 1020 asserts a select signal to multiplexer 1030 to select the restricted way mask when the miss address is within a restricted range or to select the normal way mask when the miss address is not within a restricted range. It will be appreciated that the address range fields 1023 and 1033 can further include both a beginning address (ADDR_L) and an ending address (ADDR_H) that indicate an address range. In an alternate embodiment, only a beginning address range is needed when there is an implied length associated with the address range. For example, a single address can identify the first byte of an address range having a fixed size. In another embodiment, a base address can be provided along with an address mask, wherein the address mask is applied to a current address to obtain a masked address result that is compared to the base address. When the masked address is the same as the base address the current address is within a range specified by a value at the address mask register.

In one embodiment, registers 1010, 1022, and 1032 are user definable registers of the programmer's model of an integrated device.

The way mask selected at multiplexer 1030 is used by the way select module 1040 to exclude specific ways from consideration from a cache select process that determines which one of the available caches ways will store the TAG and information that caused the cache miss. Basing a way select process on the address causing the miss provides the ability for specific portions of instruction space and information space to be cached differently to prevent code or information that is more important that other code or information from being evicted from the cache. For example, a cache way that includes an interrupt routine or information that is high priority information can be protected from being evicted from cache by lower priority routines or information, thereby improving performance of a system. This embodiment allows an application to reserve specific cache ways for certain types of information while still allowing other ways of the cache to store lower priority information. This allows multiple ways to be allocated between more and less critical information in an embedded system to optimize system performance.

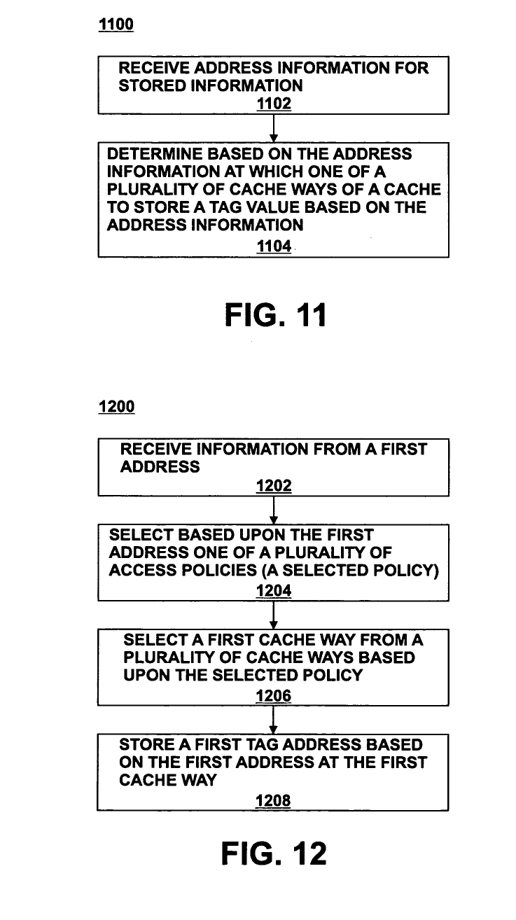

FIG. 11 illustrates a method in accordance with a specific embodiment of the present disclosure. At 1111, address information is received for stored information that caused a cache miss and is therefore to be cached. In one embodiment, the address information identifies a specific storage location in either physical or logical memory space. At 1112, it is determined which one of a plurality of cache ways of a cache is to store the tag value based on the address information that caused the cache miss. The information causing the cache miss is stored at a cache line associated with the written cache tag.

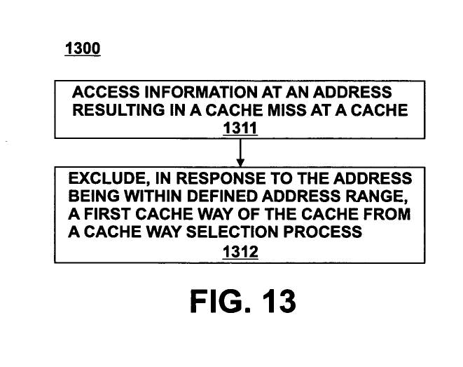

FIG. 12 illustrates a method in accordance with a specific embodiment of the present disclosure. At 1211, information is received from a first address. At 1212, one of a plurality of access policies is selected based upon the first address. For example, each way mask controls a different access policy, and therefore, one of a plurality of cache way masks is selected based upon the first address received at 1211. At 1213, a first cache way is selected from a plurality of cache ways based upon the selected policy. At 1114, a first tag address that is based on the first address is stored at the first cache way. For example, a defined number of the most significant bits of the first address are stored as the first tag address at the first cache way.

FIG. 13 illustrates a method in accordance with a specific embodiment of the present disclosure. At 1311, information at an address resulting in a cache miss is accessed. At 1312, a first cache way of the cache is excluded from a cache way selection process in response to the address being within the defined address range. As previously discussed, the address ranges can be user definable.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
requesting information at an address resulting in a cache miss at a cache; and
excluding from a cache way selection process in response to the address being within a defined address range, a first cache way of the cache.

2. The method of claim 1 further comprises reading a user definable location to determine the defined address range.

3. The method of claim 2 wherein the defined address range includes a beginning address.

4. The method of claim 3 wherein the defined address range includes an ending address.

5. The method of claim 1 wherein the information comprises an instruction.

6. The method of claim 1 wherein the information comprises application data.

7. A method comprising:
receiving address information for stored information; and
determining based on the address information at which one of a plurality of cache ways (a selected cache way) of a cache to store a tag value based on the address information as part of a cache allocation operation.

8. The method of claim 7 wherein determining further comprises determining one of a plurality of cache way masks based on the address information to be used to determine the selected cache way.

9. The method of claim 8 wherein at least two corresponding cache way masks of the plurality of cache way masks are associated with corresponding memory ranges.

10. The method of claim 9 wherein a beginning address of each corresponding memory range is user definable.

11. The method of claim 10 wherein an ending address of each corresponding memory range is user definable.

12. The method of claim 11 wherein each cache way mask of the plurality of cache way masks is user definable.

13. The method of claim 11 wherein a mask state of a first cache way of the plurality of cache ways is stored at a first offset location within each corresponding one of the plurality of cache way masks, and a mask state of a second cache way of the plurality of cache ways is stored at a second offset location within each corresponding one of the plurality of cache way masks.

14. The method of claim 13 wherein the first offset location is a first bit location and the second offset location is a second bit location.

15. The method of claim 14 wherein the address information is within instruction space.

16. The method of claim 14 wherein the address information is within data space.

17. A method comprising:
receiving information from a first address;
selecting based upon the first address one of a plurality of access policies (a selected policy);
selecting a first cache way from a plurality of cache ways based upon the selected policy; and
storing a first tag address based on the first address at the first cache way.

18. A system comprising:
a register comprising an address field and a mask field;
a cache memory comprising a plurality of cache ways; and
a cache controller coupled to the cache memory, the register, and an address bus to determine based on information at the address bus and the address field whether the mask register is to be used to select one cache way from the plurality of cache ways.

19. The system of claim 18, wherein the mask field comprises a plurality of mask locations, each mask location of the plurality of mask locations corresponding to a cache way of the plurality of cache ways.

20. The system of claim 18, wherein the cache controller further comprises a comparator coupled to the address bus and to the address field to determine whether the mask field is to be used.
